(19) United States
(12) Patent Application Publication
(10) Pub. No.: US 2004/0205695 A1
(43) Pub. Date: Oct. 14, 2004

(54) Method and system for web application builder

(75) Inventor: David Fletcher, Whitby (CA)

Correspondence Address: Irah H. Donner, Hale and Dorr LLP, The Willard Office Building, 1455 Pennsylvania Avenue, Washington, DC, 20186, US

(73) Assignee: Homeproject.com, Inc., Richmond, ON (CA)

(21) Appl. No.: 09/820,806

(22) Filed: Mar. 30, 2001

(30) Foreign Application Priority Data
Feb. 16, 2001 (CA) 2,337,117

(51) Int. Cl. G06F 9/44; G06F 9/46

(52) U.S. Cl. 717/105; 719/328

(57) ABSTRACT

A system for building web applications in a client-server computing environment, including a server-side software engine including a database interface for a database of three-dimensional graphics objects, and a web application configuration file including initialization settings for a server computer and design settings for a graphical user interface for a web application, and a client-side software engine including a programming interface for developer plug-ins that render the three-dimensional graphics objects, and a web application user interface manager that provides a user interface for the web application based on contents of the configuration file. A method is also described and claimed.

### FIELD OF THE INVENTION

The present invention relates to web application development, and specifically to web applications involving three-dimensional graphics objects.

### BACKGROUND OF THE INVENTION

Development of web applications using graphical objects involves mastery of many different sophisticated software technologies and standards, including web servers, web browsers, TCP/IP and HTTP communication protocols, HTML page design, operating systems (windows management, file management, I/O), multi-threading, database management, compression and, of course, image processing. Developers are often faced with a choice of either developing much of the needed technology themselves, or integrating many third-party software components within their own software systems. The first choice requires acquiring skill with a diverse spectrum of software systems, and the second choice requires acquiring skill with third-party software interfaces.

In fact, typically the distinguishing features of one graphical web application over others are the graphical user interface and the controls enabled thereby. Thus, developers who are often only interested in designing user interfaces and controls for their own applications often find themselves dealing with overall Internet system software architectures, and buried in core operating system, Internet and database software systems.

As such, there is a need for a web application builder that enables developers to focus on the unique design and features of a user interface for their own application, without the need to deal with core operating system, Internet and database management software.

Prior art web application builders, specifically involving three-dimensional graphics objects, can be grouped into two categories: (1) web-based visualization applications for viewing three-dimensional objects, and (2) web-based application tools.

Visualization applications include, but are not limited to, (i) VIEWPOINT™, developed by Viewpoint Corporation of New York, N.Y. and having a website at http://www.viewpoint.com/, (ii) CULT3D®, developed by Cycore AB of Uppsala, Sweden and having a website at http://www.cycore.com/, (iii) OPENSPACE 3D®, developed by Virtus Entertainment of Cary, N.C. and having a website at http://www.virtus.com/, and (iv) VIRTUE3DT™, developed by Virtue Ltd. of Haifa, Israel and having a website at http://www.virtue3d.com/. These applications typically compress individual three-dimensional objects and efficiently transmit them over the Internet to be viewed in a client browser. However, these applications typically do not provide the ability to customize the viewing interface, or to easily build on their technology for the creation of more sophisticated web applications.

There are many web-based application tools currently available, including FLASH® and SHOCKWAVE® from Macromedia. Inc. of San Francisco, Calif., COLD FUSION® from Allaire Corporation of Newton, Mass., and the Windows DNA technologies from Microsoft Corporation of Redmond, Wash. While these application tools make it reasonably easy to create web-based, interactive, applications, they do not provide easy integration with back-end product databases, or they do not provide extensive three-dimensional graphics capabilities, or they do not allow for a simple yet flexible method for configuring the user interface presented to the client.

### SUMMARY OF THE INVENTION

The present invention provides a method and system for building web applications.

There is thus provided in accordance with a preferred embodiment of the present invention a system for building web applications in a client-server computing environment, including a server-side software engine including a database interface for a database of three-dimensional graphics objects, and a web application configuration file including initialization settings for a server computer and design settings for a graphical user interface for a web application, and a client-side software engine including a programming interface for developer plug-ins that render the three-dimensional graphics objects, and a web application user interface manager that provides a user interface for the web application based on contents of the configuration file.

There is further provided in accordance with a preferred embodiment of the present invention a method for building web applications in a client-server computing environment, including creating a database of three-dimensional graphics objects residing on a server computer, programming a plug-in, for use by a client web application, for a client computer to render the three-dimensional graphics objects, and specifying a configuration file, residing on the server computer, including initialization settings for a server computer and design settings for a graphical user interface for the web application.

### BRIEF DESCRIPTION OF THE DRAWINGS

The present invention will be more fully understood and appreciated from the following detailed description, taken in conjunction with the drawings in which:

FIG. 1 is a simplified block diagram of a client-server system for web application developed in accordance with a preferred embodiment of the present invention;

FIG. 2 is a simplified diagram indicating components included within a client engine;

FIG. 3 is a sample drawing of a web application for designing a garden, in accordance with a preferred embodiment of the present invention; and

FIG. 4 is a sample drawing of a three-dimensional object from a database of home interior design objects, used in conjunction with a preferred embodiment of the present invention.

### LIST OF APPENDICES

Appendix A is a listing of a sample server configuration file for describing a user interface for a web-based garden design and for setting various parameters, used in an embodiment of the present invention;

Appendix B is a listing of a sample configuration file for describing the hierarchical structure for objects stored in an object database, for a web-based garden design application; and

Appendix C is a listing of part of an application programming interface (API) for developers to build a web application using a preferred embodiment of the present invention.

### DETAILED DESCRIPTION OF A PREFERRED EMBODIMENT

The present invention provides a method and system for building web applications. In a preferred embodiment the present invention can be used to build graphics applications using three-dimensional objects, such as an application that enables a user to design his own furniture arrangement for interior decoration of rooms in a home, or an application that enables a user to design his own landscape and horticulture for a garden.

In a preferred embodiment a web application developer using the present invention provides a database of objects used to store three-dimensional objects and their associated data, and a client browser plug-in used to render the three-dimensional objects.

The present invention includes a client engine and a server engine. The client engine includes an application programming interface (API) through which the browser plug-in interfaces with a web application. The server engine interfaces with the object database and sends object data to the client as required. The server engine also provides a developer with a configuration file, used to define the structure of the object database and the “look and feel” of the user interface for a web application.

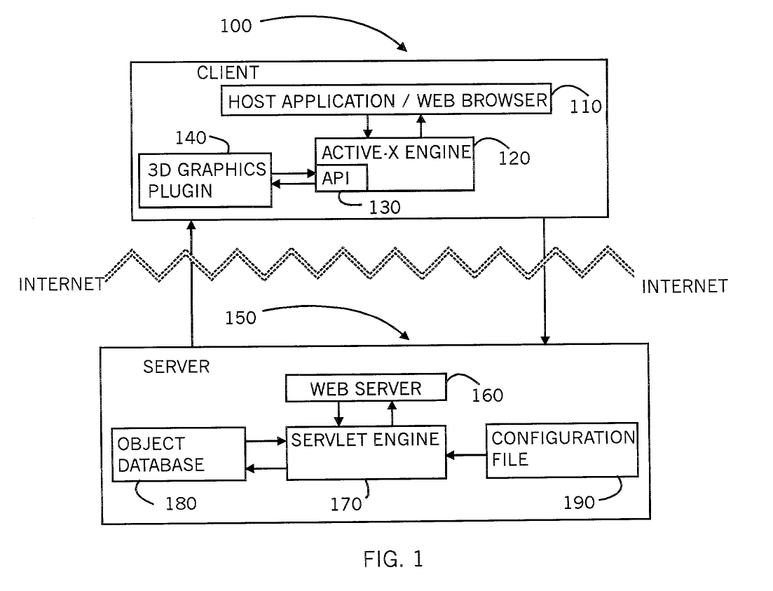

Reference is now made to FIG. 1, which is a simplified block diagram of a client-server system for a web application developed in accordance with a preferred embodiment of the present invention. Shown in FIG. 1 is a client computer 100 including a host application 110. Host application 110 is preferably an application that can host ActiveX controls on a Windows platform. In a preferred embodiment host application 110 is an Internet browser, such as Netscape Navigator® or Microsoft Explorer®. Client computer 100 also includes a client engine 120, which is preferably an ActiveX control on Windows-based client computers, or another suitable dynamically loaded code fragment. Client engine 120 takes over control of client computer 100 when a web application developed using the present invention is launched.

Client engine 120 includes an API 130 through which plug-in 140 for three-dimensional graphics can interface. Whenever client engine 120 is called upon to render a three-dimensional object, it calls plug-in 140.

Also shown in FIG. 1 is a server computer 150 including a web server 160, such as the iPlanet® Web Server and the Microsoft® Enterprise Server. Web server 160 connects to a server engine 170, which is preferably a Java servlet. Server engine 170 connects to a database 180 of three-dimensional objects. Server engine 170 also connects to a configuration file 190, which is sent over the Internet to client 100 at the start of the web application, and used by client engine 120 to understand the hierarchical structure of database 180, and to understand the design of a user interface for the web application.

Each object stored within database 180 includes an identifier for the object and ancillary data for the object. Preferably, the identifier is a text string including a category ID, a manufacturer ID, a type ID and an item ID. The identifier preferably also includes a version number, to allow for updates to database 180. Configuration file 190 may include a list of objects in database 180 and their identifiers. Thus when client engine 120 initially receives configuration file 190, it knows about the object data initially residing within database 180 and current version numbers for each object.

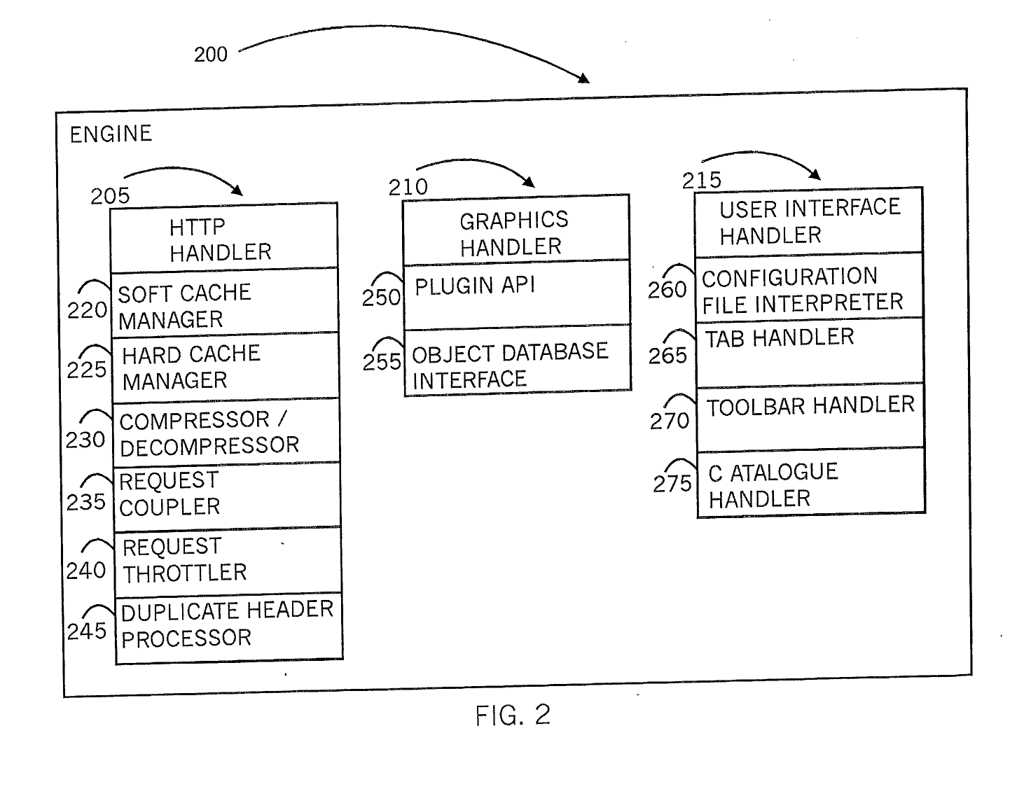

Reference is now made to FIG. 2, which is a simplified diagram indicating components included within client engine 120. As shown in FIG. 2, client engine 120 includes three handlers: an HTTP handler 205, a graphics handler 210 and a user interface handler 215.

HTTP handler 205 includes a soft cache manager 220, a hard cache manager 225, a compressor/decompressor 230, a request coupler 235, a request throttler 240 and a duplicate header processor 245. Graphics handler 210 includes a plug-in API 250 and an object database interface 255. User interface handler 215 includes a configuration file interpreter 260, a tab handler 265, a toolbar handler 270 and a catalog handler 275. Each of these components will now be described.

Soft Cache Manager 220

Soft cache manager 220 maintains a temporary cache of object data within volatile memory of client 100 (FIG. 1), typically random access memory (RAM).

Hard Cache Manager 225

Hard cache manager 225 maintains a cache of object data on a hard drive of client 100 (FIG. 1), as object data is dynamically received by client 100 from server 150. Based on configuration file 190, hard cache manager 225 can keep track of versions for cached objects. Hard cache manager 225 updates its cached object data whenever client 100 receives object data with a higher version number than that of the cached object.

Compressor/Decompressor 230

Compressor/decompressor 230 compresses request data going out and decompresses response data coming in. In a preferred embodiment of the present invention, compressor/decompressor 230 also compresses hard-cache data.

Request Coupler 235

Request coupler 235 combines multiple HTTP requests into a single request in order to speed up the web application. Each HTTP request typically causes a new socket to be opened, and this creates a significant delay in application performance. By combining multiple HTTP request into a single request, one socket can service multiple requests, thereby speeding up application performance.

Request Throttler 240

Request throttler 240 controls the sending of HTTP requests from client 100 to server 150, in order not to exceed a maximum allowed number of concurrent requests. When too many HTTP requests arrive, request throttler 240 queues some of them as pending requests, until some in-process requests are completed.

Duplicate Header Processor 245

Duplicate header processor 245 identifies multiple HTTP requests from client 100 with identical headers. Duplicate header processor 245 sends only one of the duplicate requests to server 150, and distributes the response data to the various multiple request sources.

Duplicate requests can arise, for example, when a user is working with multiple identical objects. In a home design application, including objects for furniture, a user may be placing several identical chairs in a room, and positioning each one differently. The data for each of the chairs is identical, and need only be sent to client 100 once. Duplicate header processor 245 knows to retrieve the data from a chair object only once, and distribute this data to each of the chair objects placed within the room.

Plug-in API 250

Plug-in API 250 includes bi-directional interfaces for plug-in 140. Plug-in 140 includes one or more dynamic link libraries (DLLs) or similar code fragments supplied by a developer of a web application. The plug-in includes methods for processing object data received from object database 180 and rendering the corresponding objects. The plug-in API manages the dynamic loading of these DLLs, and the ongoing interaction between the plug-in and client engine 200. The API also includes methods and functions that enable the plug-in to perform advanced functions. Reference is now made to Appendix C, which illustrates a sample plug-in API providing methods and functions for compression, image manipulation, interaction with host application 110, communication with server 150, and interaction with catalog handler 275.

Object Database Interface 255

Object database interface 255 receives object data from object database 180 and organizes the data for presentation to plug-in 140.

Configuration File Interpreter 260

Configuration file interpreter 260 parses configuration file 190 received from server 150, extracts the relevant information relating a user interface (UI) of a web application, and customizes the UI accordingly.

Tab Handler 265

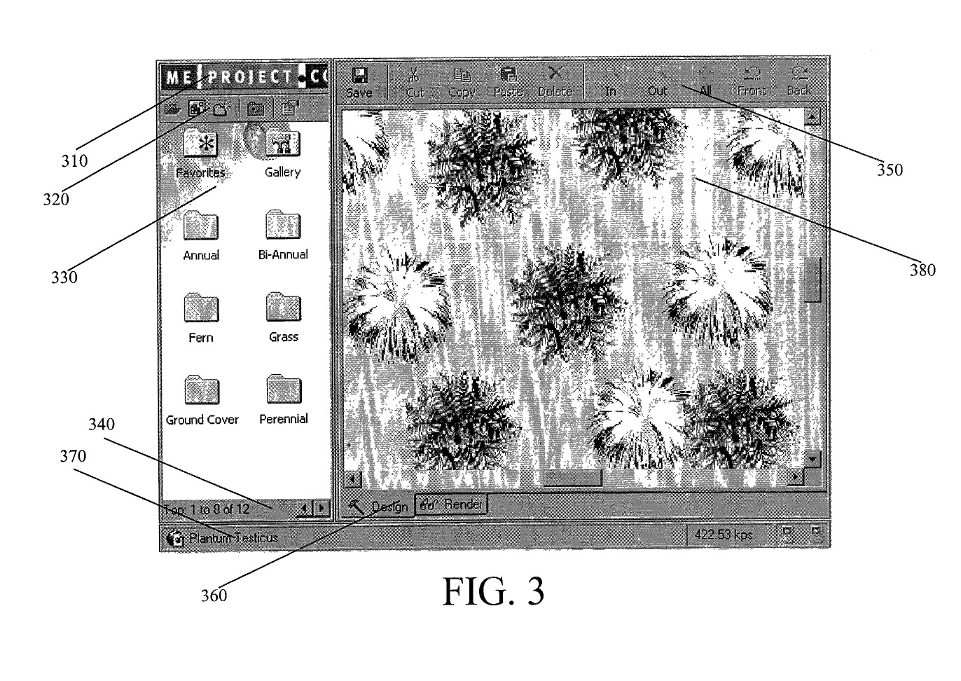

Tab handler 265 handles tabs within an application window in a fashion consistent with the operating system of host computer 100, such as tabs illustrated in tab window 360 (FIG. 3).

Toolbar Handler 270

Toolbar handler 270 handles controls displayed within a toolbar in a fashion consistent with the operating system of host computer 100, such as toolbar 350 (FIG. 3).

Catalog Handler 275

Catalog handler 275 handles catalog windows, such as windows 330 and 380 (FIG. 3).

In a preferred embodiment, a developer of a web application using the present invention creates a configuration file, which is a text file with instructions to a server computer for initialization settings and for settings for a user interface. An example of such a configuration file is presented in Appendices A and B, and described hereinbelow.

Reference is now made to FIG. 3, which is a sample drawing of a user interface of a web application for designing a garden, constructed in accordance with a preferred embodiment of the present invention. The user interface illustrated in FIG. 3 corresponds substantially with the configuration file listed in Appendix A. The user interface in FIG. 3 illustrates a catalog of garden objects. The user interface includes a branding bitmap 310 at a top left portion of the application window, a catalog toolbar 320 underneath the branding bitmap, a catalog contents window 330, a previous/next navigational control 340 underneath the catalog contents window, a top toolbar 350 with controls to assist in designing a garden, a tabs window 360, a status bar 370 at the bottom of the application window, and a main contents window 380 including three-dimensional graphical objects from the catalog.

Branding Bitmap 310

Branding bitmap 310 is retrieved from the server. It is identified by the lines

[CATALOG]

TITLE=BRANDING

in the configuration file listed in Appendix A.

Catalog Toolbar 320

Catalog toolbar 320 displays a set of static commands with availability controlled by the configuration file using the ICON=XXXX tokens. Specifically, toolbar 320 corresponds to the section

ICON=TOP

ICON=GALLERY

ICON=FAVORITES

ICON=SEPERATOR

ICON=PREVIOUS

ICON=SEPERATOR

ICON=PROPERTIES

in the configuration file listed in Appendix A.

Catalog Contents Window 330

Catalog contents window 330 is completely definable on the server side. Chains in the configuration file identify both the hierarchy, and the icons and text used to identify them. These are typically cached and version controlled by the configuration file. Specifically, catalog contents window 330 corresponds to chains listed in Appendix B.

Previous/Next Navigational Control 340

The text in previous/next navigational control 340 is controlled by the engine but, as with all text, the strings are loaded from the server at initialization similar to a remote window's resource file.

Top Toolbar 350

Top toolbar(s) 350 are set by the server, together with the look and functionality. Specifically, top toolbar 350 corresponds to the section

[TOOLBAR]

ID=1

BUTTON=101

BUTTON=−1

BUTTON=102

BUTTON=103

BUTTON=104

BUTTON=105

BUTTON=−1

BUTTON=110

BUTTON=111

BUTTON=112

BUTTON=120

BUTTON=121

in the configuration file listed in Appendix A. When a tool button is selected, its ID is passed both to a web page and to an active plugin for custom processing.

Tab Window 360

Tab window(s) 360 function similar to the tool buttons, and are used to manage multiple client windows. Specifically, tab window 360 corresponds to the section

[CLIENTTAB]

PROMPT=Design

ICON=0

ID=1

HELP=Garden Layout

[CLIENTTAB]

PROMPT=Render

ICON=1

ID=2

HELP=3D Garden View

in the configuration file listed in Appendix A. Like all interface components, the tabs can be controlled remotely or by an active plugin.

Status Bar 370

Status bar 370 consists of a branding mark, a status text, a flow rate and an active connection status. The status text is loaded from the server and controlled by the plugin.

Main Content Window 380

Main content window(s) 380 are created by the engine via an API, with the plugin determining when to override default processing.

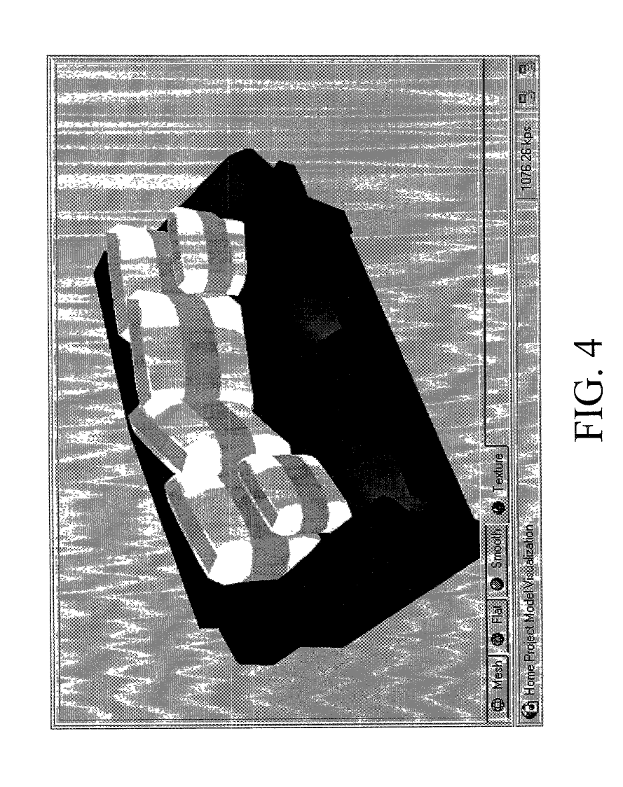

Reference is now made to FIG. 4, which is a sample drawing of a three-dimensional object from a database of home interior design objects, used in conjunction with a preferred embodiment of the present invention.

Implementation Details

As mentioned hereinabove, in a preferred embodiment, a developer of a web application using the present invention creates a configuration file, which is a text file with instructions to a server computer for initialization settings and for settings for a user interface.

Reference is now made to Appendix A, which is a listing of a sample configuration file for describing a user interface for a web-based garden design application and for setting various parameters, used in an embodiment of the present invention. The listed sample file is a text file including eleven data sections. It begins with a first data section for server parameters, which includes a server version number and specified directories, typically on the server, for storing cached data and for locating modules.

The second data section of the sample file listed in Appendix A includes startup parameters. The third data section includes parameters for a status bar of a web application. The fourth data section includes control parameters for auto-updating the client. The fifth data section includes parameters for a catalog interface, used to present the user with a visual catalog of three-dimensional data objects that are available to the application. The sixth data section includes parameters for a client user interface for the application.

The seventh data section includes parameters for client tab settings. Tabs are used by the application to navigate from one view to another. The sample file indicates that a user can switch between a “garden layout” and a “3D garden view.”

The eighth data section includes parameters for tools available to the client. The sample listing includes twelve tools as follows: “Save your garden design,” “Cut plant(s),” “Copy plant(s),” “Paste plant(s),” “Delete plant(s),” “Zoom in on the plants,” “Zoom out from the garden,” “Zoom all plants into the garden view,” “Bring plant forward,” “Send plant backwards,” “Zoom in on the 3D garden” and “Zoom out from the 3D garden.”

The ninth data section includes parameters for toolbars of the application. The sample listing describes a first toolbar including ten buttons as follows: “Save” (ID=101), “Cut” (ID=102), “Copy” (ID=103), “Paste” (ID=104), “Delete” (ID=105), “In” (ID=110), “Out” (ID=111), “All” (ID=112), “Front” (ID=120) and “Back” (ID=121). The sample listing also describes a second toolbar including three buttons as follows: “Save” (ID 101), “In” (ID=130) and “Out” (ID=131).

The tenth data section includes parameters for localization settings including various text strings used by the application. The eleventh data section includes version control parameters for catalog items and icons.

Reference is now made to Appendix B, which is a listing of a sample configuration file for describing the hierarchical structure for objects stored in database 180 (FIG. 1), for a web-based garden design application. For example, an object category “chair” may include a “rocking chair” object and a “dining room chair” object. The listed sample file is a text file including five data sections. It begins with a first data section describing the world (i.e., global) chain of object relationships. The sample world chain includes twelve children, as follows: a favorites chain (ID=1), a gallery chain (ID=2), an “annual” object category (ID=10), a “bi-annual” object category (ID=11), a “fern” object category (ID=12), a “Grass” object category (ID=13), a “ground cover” object category (ID=14), a “perennial” object category (ID=15), a “shrub” object category (ID=16), a “succulent” object category (ID=17), a “tree” object category (ID=18) and a “vine” object category (ID=19).

The second data section of the sample file listed in Appendix B includes a description of a favorites chain. The third data section includes a description of a gallery chain. The fourth data section includes a description of a search chain.

The fifth data section includes a description of ten main chains. For example, the object with ID=10 is an object category for “annuals,” and includes two children. The object with ID=12 is an object category for “fern,” and also includes two children.

Reference is now made to Appendix C, which is a listing of part of an application programming interface (API) for developers to build a web application using a preferred embodiment of the present invention.

In reading the above description, persons skilled in the art will realize that there are many apparent variations that can be applied to the methods and systems described. For example, the configuration file described with reference to Appendix A may alternatively be an XML document. Similarly, the configuration file for describing the hierarchical structure for objects, described with reference to Appendix B, may also be an XML document. It is noted that XML documents are particularly suitable for describing hierarchical data structures.

It will be appreciated by persons skilled in the art that the present invention is not limited by what has been particularly shown and described hereinabove. Rather the present invention includes combinations and sub-combinations of the various features described hereinabove as well as modifications and extensions thereof which would occur to a person skilled in the art and which do not fall within the prior art.

What is claimed is:

1. A system for building web applications in a client-server computing environment, comprising:
a server-side software engine comprising:
a database interface for a database of three-dimensional graphics objects; and
a web application configuration file including initialization settings for a server computer and design settings for a graphical user interface for a web application; and
a client-side software engine comprising:
a programming interface for developer plug-ins that render the three-dimensional graphics objects; and
a web application user interface manager that provides a user interface for the web application based on contents of the configuration file.

2. The system of claim 1 wherein the database of three-dimensional graphics objects includes an object identifier for each graphics object stored therewithin, and wherein the object identifier includes a version number.

3. The system of claim 2 wherein the object identifier also includes a category identifier.

4. The system of claim 2 wherein the object identifier also includes a manufacturer identifier.

5. The system of claim 2 wherein the object identifier also includes a type identifier.

6. The system of claim 2 wherein the object identifier also includes an item identifier.

7. The system of claim 1 wherein said server-side software engine further comprises a web server extension for sending database data to a client computer.

8. The system of claim 1 wherein said server-side software engine further comprises:
an HTTP request decompressor; and
an HTTP response compressor.

9. The system of claim 8 wherein said client-side software engine further comprises:
an HTTP request compressor; and
an HTTP response decompressor.

10. The system of claim 1 wherein said client-side software engine further comprises a soft cache manager.

11. The system of claim 1 wherein said client-side software engine further comprises a hard cache manager.

12. The system of claim 1 wherein said client-side software engine further comprises an HTTP request coupler.

13. The system of claim 1 wherein said client-side software engine further comprises an HTTP request throttler to control HTTP requests so that the number of concurrent requests being processed by the server computer does not exceed a maximum permitted number of requests.

14. The system of claim 1 wherein said client-side software engine further comprises an HTTP duplicate header processor.

15. A method for building web applications in a client-server computing environment, comprising:
creating a database of three-dimensional graphics objects residing on a server computer;
programming a plug-in, for use by a client web application, for a client computer to render the three-dimensional graphics objects; and
specifying a configuration file, residing on the server computer, including initialization settings for a server computer and design settings for a graphical user interface for the web application.

16. The method of claim 15 wherein the database of three-dimensional graphics objects includes an object identifier for each graphics object stored therewithin, and wherein the object identifier includes a version number.

17. The method of claim 16 wherein the object identifier also includes a category identifier.

18. The method of claim 16 wherein the object identifier also includes a manufacturer identifier.

19. The method of claim 16 wherein the object identifier also includes a type identifier.

20. The method of claim 16 wherein the object identifier also includes an item identifier.

21. The method of claim 15 further comprising:
compressing HTTP requests, by the client computer;
decompressing HTTP responses, by the client computer;
compressing HTTP responses, by the server computer; and
decompressing HTTP requests, by the server computer.

22. The method of claim 15 further comprising managing a soft cache on the client computer.

23. The method of claim 15 further comprising managing a hard cache on the client computer.

24. The method of claim 15 further comprising coupling HTTP requests.

25. The method of claim 15 further comprising throttling HTTP requests, so that the number of concurrent requests being processed by the server computer does not exceed a maximum permitted number of requests.

26. The method of claim 15 further comprising processing, by the client computer, HTTP requests that have identical headers.
